(19) United States
(12) Patent Application Publication
(10) Pub. No.: US 2018/0226165 A1
(43) Pub. Date: Aug. 9, 2018

(54) METHODS AND DEVICES FOR BETA RADIOISOTOPE ENERGY CONVERSION

(71) Applicant: Ayers Group, LLC, Princeton, NJ (US)

(72) Inventor: William M. Ayers, Princeton, NJ (US)

(73) Assignee: Ayers Group, LLC, Princeton, NJ (US)

(21) Appl. No.: 15/860,996

(22) Filed: Jan. 3, 2018

Related U.S. Application Data
(60) Provisional application No. 62/441,882, filed on Jan. 3, 2017.

(51) Int. Cl. G21H 1/12

(52) U.S. Cl. CPC G21H 1/12

(57) ABSTRACT

A power or photon source uses beta electrons emitted by a radioisotope. The beta electrons encounter a magnetic field which can confine them into helical trajectories to efficiently generate excimer photons from a precursor gas. In electrical power generation embodiments, the emitted photons are used to ultimately generate electricity. The photons, or derivative photons emitted by a phosphor, can be absorbed by photovoltaic cell(s) to generate the electrical power.

### BACKGROUND

Aspects of the present disclosure relate generally to energy conversion, and in certain embodiments provide devices and methods for the utilization of a beta electron emitting radioisotope material in the generation of photons and/or electrical power.

As further background, unattended, long-life power sources are needed for electronic devices in isolated undersea vehicles, sensor systems, spacecraft, and Lunar or Mars base stations. Powering such devices with beta electron emitting radioisotope sources rather than rechargeable batteries systems can decrease weight, provide extremely low temperature operation, decrease maintenance, and increase system longevity.

Attempts to efficiently convert radioisotope beta electron charge and kinetic energy into electrical power have been pursued for decades. However, present approaches still capture only a very small fraction of energy available from the beta electrons. In previous methods, the energy conversion device materials are degraded by beta electron bombardment thereby reducing the device lifetime and power output.

One class of beta radioisotope power device, betavoltaic cells, are reviewed in “Advances in Betavoltaic Power”, incorporated by reference herein. In these cells, beta electrons from radioisotope sources penetrate a semiconductor material to produce electron-hole pairs. The electron-hole pairs are separated by a Schottky or PIN junction in the semiconductor to produce electrical power. The devices have very low, nanowatt to microwatt power output and very low conversion efficiencies as disclosed in U.S. Pat. No. 8,017,412 B referenced herein. A major problem with betavoltaic cells is destruction of the semiconductor material from the beta electron bombardment. Approaches to prevent such damage are disclosed in US Application 2013/0264907 A1 referenced herein. However, the damage is accelerated as more radioisotope is loaded into the device. This limits the maximum power output available from the betavoltaic approach. Commercial betavoltaic cells have maximum radioisotope loadings of about two to three Curies.

Another method for energy conversion relies on generating excimer light by excitation of noble gas atoms with charged particles from fission by-product radioisotopes. As described in Laser and Particle Beams, Vol. 6, p. 25-62 (1988) referenced herein, a noble gas excimer state that emits photons can be generated with high energy alpha and beta emissions from uranium oxide and fission by-product radioisotopes. The radioisotopes are in the form of finely divided particle aerosols which are mixed in with and kept suspended in the noble gases. The light emission into a photovoltaic cell generates power. A major problem with this approach is the danger of the uranium and fission by-product radioisotope aerosols escaping from the device as well as disposal problems associated with these long half-life radioactive materials.

Excimer light sources can also be produced with an electron gun driven by an external high voltage power supply as described in “Development of Electron Guns for Excimer Light Sources in Vacuum” referenced herein. Electron excimer light generation from krypton, argon, and xenon gases as well as heterogeneous gas mixtures such as KrF, KrCl, ArF, and ArCl are described in “Excimer Lamps” and “Vacuum Ultraviolet Rare Gas Excimer Light Source” referenced herein. These studies show excimer generation requires a two or three atom excited state complex. Electron beam ionization of the gas into a plasma of additional electrons and ionized gas atoms also increases the excimer generation rate. Thus, the excited state, plasma, and excimer generation rates are enhanced by high precursor gas pressure, high electron energy and increased electron flux (electrons/cm²-sec).

### SUMMARY

In certain aspects, provided in this disclosure are devices for energy conversion. The devices include a beta electron emitting radioisotope and an enclosed space adjacent to the beta electron emitting radioisotope, for receiving beta electrons emitted by the radioisotope. An excimer precursor gas is sealed within the enclosed space. The excimer precursor gas is selected to generate photons when excited by beta electrons emitted by the radioisotope and entering the enclosed space. A magnetic field is provided and is effective to impart helical trajectories to the beta electrons emitted by the radioisotope and entering the enclosed space, wherein the helical trajectories extend at least in part through the enclosed space.

In additional aspects, provided in this disclosure are methods for energy conversion. The methods include emitting beta electrons from a beta electron emitting radioisotope and into an enclosed space containing an excimer precursor gas selected to generate photons when excited by the beta electrons. The methods also include applying a magnetic field so as to impart helical trajectories to the beta electrons emitted by the radioisotope and entering the enclosed space, wherein the helical trajectories extend at least in part through the enclosed space.

In some preferred forms, the devices and methods described herein may overcome maximum power limits and materials destruction of prior known beta radioisotope power generation devices. In preferred forms, the devices and methods provide high efficiency, high power beta radioisotope energy conversion to electrical power on a continuous basis without degradation of the energy conversion device materials. In especially preferred embodiments, the devices include, and the methods employ, components that:

(1) contain a high Curie content beta electron emitting radioisotope inside a replaceable, sealed, beta transparent tube that allows the beta electrons to pass through the tube wall while retaining the radioisotope inside; and/or

(2) provide a permanent magnetic field aligned with the beta emitting tube axis such that the magnetic field interacts with the emitted beta electrons through the Lorenz force to confine and collimate the beta electrons into helical trajectories around the tube; and/or

(3) provide a sealed photon transparent tube, containing a pressurized excimer precursor gas, that surrounds and is concentric with the radioisotope tube, such that the helical beta electron trajectories have numerous interactions with the precursor gas atoms to generate an intense light source from excimer photons; and/or

(4) provide photovoltaic cells around the photon transparent tube to convert the emitted excimer photons into electrical power on a continuous basis

Magnetic confinement of the beta electrons to helical trajectories through the excimer precursor gas can dissipate their energy through interactions with the gas atoms and excimer photon generation. In this manner, little, no or lesser damage is done to the device materials or the photovoltaic cells or degradation in the device performance over time, e.g. as compared to semiconductor betavoltaic cells. The protection provided by the magnetically confined beta electron trajectories can also allow the device to be loaded with more than 1000 Curies of radioisotope to generate milliwatt to watt levels of electrical power. Preferred devices are also simple to manufacture since the sealed radioisotope tube is separate from the excimer precursor gas tube and photovoltaic cells.

Additional embodiments, as well as features and advantages thereof, will be apparent to those of ordinary skill in the art from the descriptions herein.

### BRIEF DESCRIPTION OF THE DRAWINGS

The drawings illustrate certain embodiments presently contemplated.

FIG. 1 provides a schematic illustration of a beta transparent tube containing a radioisotope with two permanent magnets providing an axial magnetic field to contain the beta electrons in helical trajectories

FIG. 2 provides an illustration of a beta electron emitting tube surrounded by a concentric photon transparent tube containing an excimer precursor gas.

FIG. 3 provides a cross-sectional view of the device in FIG. 2.

FIG. 4 provides an illustration of multiple stacked devices and a ring of devices surrounded by a hexagonal arrangement of photovoltaic panels to increase power output.

### DETAILED DESCRIPTION

For the purpose of promoting an understanding of the principles of the invention, reference will now be made to certain embodiments illustrated in the Figures and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

As disclosed above, in certain aspects, provided in this disclosure are devices for energy conversion. The devices include a beta electron emitting radioisotope and an enclosed space adjacent to the beta electron emitting radioisotope, for receiving beta electrons emitted by the radioisotope. An excimer precursor gas is sealed within the enclosed space. The excimer precursor gas is selected to generate photons when excited by beta electrons emitted by the radioisotope and entering the enclosed space. A magnetic field is provided and is effective to impart helical trajectories to the beta electrons emitted by the radioisotope and entering the enclosed space, wherein the helical trajectories extend at least in part through the enclosed space. The detailed descriptions which follow provide illustrative and preferred devices, and associated methods. While in some of these embodiments tubular structures are provided to serve as first and second housings defining an enclosed space between them for containing the excimer precursor gas, it will be understood that other housing configurations can also be used. Also, while devices with multiple photovoltaic cells are preferred, other devices may have only one photovoltaic cell. As well, while certain preferred materials of construction (e.g. titanium, silica, fused quartz, specific radioisotopes, etc.) and dimensions are described, it will be understood that other materials of construction and dimensions that perform the necessary functions for the disclosed devices and methods can be utilized. In addition, it is to be understood that each disclosed feature or features in the detailed description below can be combined with the features discussed in the Summary above or recited in the Claims below, to form a disclosed embodiment of the present invention.

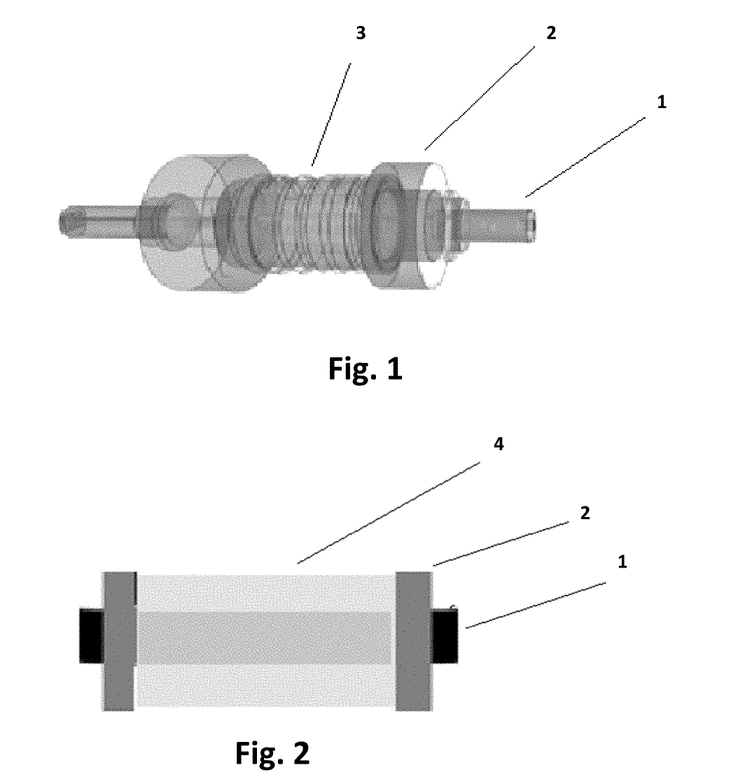

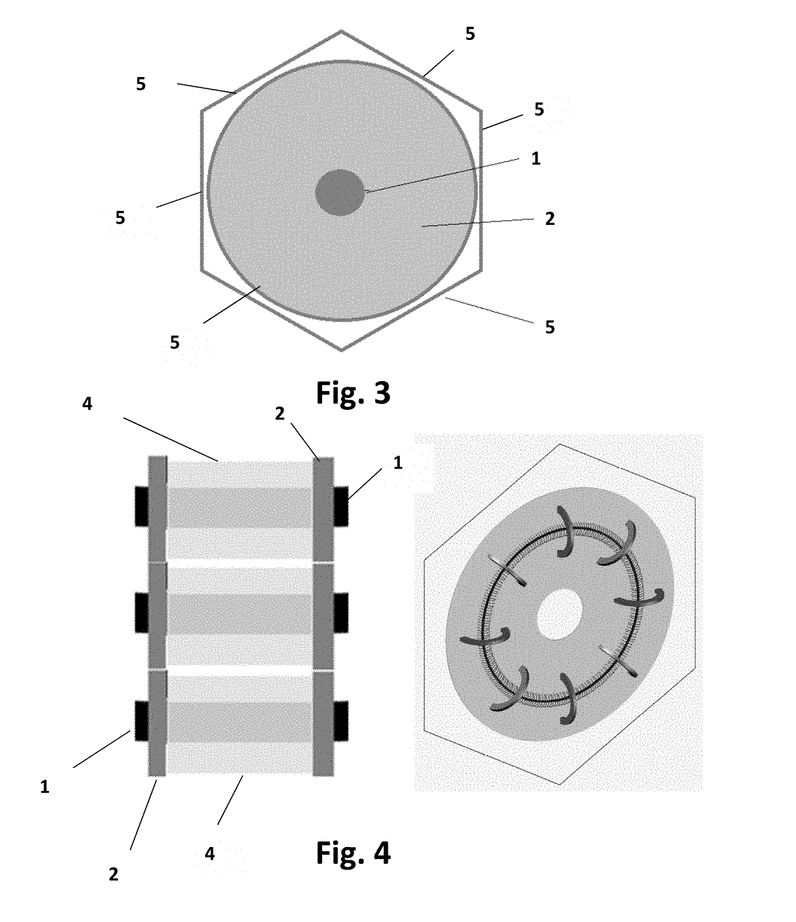

In a preferred embodiment of the device depicted FIG. 1, a thin walled titanium tube (1) containing the beta electron emitting radioisotope such as Krypton-85 gas, has two ring shaped (e.g. NdFeB) permanent magnets (2) positioned at each end of tube (1). The magnets (2) can be positioned adjacent and external of the respective ends of the tube (1). In one embodiment, the magnets are aligned to produce a uniform axial (aligned with the axis of tube (1)) magnetic field of about 0.2 Tesla. Since the titanium tube (1) is transparent to the high energy beta electrons, the Kr-85 gas remains inside the tube while the beta electrons emitted through the tube wall are confined to helical trajectories (3) around the tube by the axial magnetic field. In FIG. 2, a sealed vacuum ultraviolet photon transparent fused silica tube (4) containing an excimer precursor gas is mounted concentric to and surrounding the titanium beta emitter tube (1) to create an enclosed space located adjacent the beta electron emitting radioisotope. This photon transparent tube (4) is about the same diameter as the ring magnets (2). The kinetic energy of the emitted beta electrons is decreased by interactions with the precursor gas atoms to produce the excimer photons. As calculated below, there are tens of thousands of these interactions generating excimer photons before the kinetic energy of each beta electron is depleted. This ratio of excimer photons generated per beta electron provides a large gain factor for the device which is highly beneficial to its performance and efficiency. FIG. 3 illustrates an end view cross-section of FIG. 2 with the beta emitter tube (1), excimer generation tube (4) and six photovoltaic panels (5) surrounding the device to generate electrical power from the photons.

The device power output is a function of several factors which can include the radioisotope quantity, activity, beta energy, beta flux, excimer generation rate, and photovoltaic efficiency. The beta flux and excimer generation rate are functions of the magnetic field, excimer precursor gas composition, and pressure.

To specify the power output of the device for a particular radioisotope, the first step is to determine the number of beta electrons available for excimer generation. This is calculated from the radioisotope activity and mass inside the tube. The activity, in beta emissions per second per gram of material, is defined as:

A(t)=Ao*exp(−t/τ)(beta electrons/sec-gram) (1)

where Ao=No*MW*(ln 2/t_{1/2}) and τ=t_{1/2}/ln 2
t_{1/2} is the half-life of the radioisotope in seconds, and Ao is its initial activity in beta emissions/gram-second, No is 6.023×10²³, and MW is the molecular weight of the radioisotope. An activity of 3.7×10¹⁰ beta emissions/sec is defined as one Curie (Ci). Kr-85 has a half-life of 10.75 years thus its initial activity level is 393 Ci/gm. This is equivalent to 1.48 Ci/cm³ of Kr-85 gas at 273 K and one atmosphere pressure. Table 1 shows the initial activity of the Kr-85 beta source at various pressures. With a Kr-85 tube pressure of 100 atmospheres, pure Kr-85 can provide 148 Ci/cc. Liquid Kr-85 (at −153 C) can provide 945 Ci/cc. For the average Kr-85 beta energy of 251 KeV, the theoretical maximum power output from any device operating with 100% conversion efficiency is 2.21 milliwatts/cm³ of gas at one atmosphere pressure.

TABLE 1

| Pressure (atm) | Ci/cc |
|---|---|
| 1 (STP) | 1.48 |
| 100 | 148 |
| Liquid (−153 C.) | 945 |

One Curie of beta electron emission per second multiplied by the electron charge is equivalent to 5.92×10⁻⁹ coulombs/sec-Ci. This emission rate can be thought of as the equivalent of 5.92 nanoamps of beta electron flux passing through the beam cross sectional area.

An isolated radioisotope atom emits beta electrons in all directions or omni-directionally. The axial magnetic field collimates and focuses this omni-directional emission into a high flux (beta electrons/cm²-sec) beta electron beam. The beam is calculated from the velocity and angles of the beta electrons emitted through the titanium tube wall. For beta electrons emitted with a non-relativistic velocity amplitude, V, perpendicular (90°) to the axial magnetic field, B, the Lorenz force (qV×B) alters the beta emission straight path trajectory into a circular path with a cyclotron radius, R, as described in “Fundamentals of Electron Motion” which is incorporated herein by reference:

R=mₒV/qB (2)

where mₒ and q are the electron rest mass and charge respectively. For relativistic beta electron velocities at radioisotope decay energies greater than 25 KeV, the relativistic mass correction below is necessary to calculate the radius. The Lorenz correction factor γ is:

γ=1/sqrt(1−(V/C)²)

m=mₒ*γ

KE=mₒC²(γ−1)

Such that the kinetic energy is:

$$KE = {m}_{o} * {C}^{2} [ 1 \text{/} ( sqrt ( 1 - ( V \text{/} C ) 2 ) ) - 1 ]$$

$$and , \\ \begin{matrix}V = \frac{C \cdot \sqrt{{KE}^{2} + 2 KE \cdot mo \cdot {C}^{2}}}{KE + mo {C}^{2}} & ( 3 )\end{matrix}$$

with a cyclotron radius:

R=(mₒ*γ)V/qB (4)

Table 2 shows the velocity, effective mass and cyclotron radii for two beta emitting radioisotopes, Krypton-85 and Phosphorous-32, at their average and maximum emission energy in a magnetic field of 0.2 Tesla. Both the Kr-85 and P-32 radii require relativistic corrections.
The high beta velocities at just their average energies (>74% and >90% the speed of light respectively) provide a strong Lorenz force between the beta electrons and the permanent magnetic field.

TABLE 2

| | | | | | Radius |
|---|---|---|---|---|---|
| | Energy | Velocity | Lorenz | Velocity | at 0.2 T |
| | (KeV) | (% C) | [symbol] | (m/sec) | (mm) |
| Kr-85 | 251 | 74.29 | 1.49 | 2.22E8 | 9.40 |
| | 687 | 90.51 | 2.35 | 2.71E8 | 18.11 |
| P-32 | 695 | 90.55 | 2.36 | 2.71E8 | 18.16 |
| | 1710 | 97.35 | 4.37 | 2.91E8 | 36.20 |

In practice, the beta electrons emitted from the radioisotope atoms inside the tube exit the tube wall at angles, θ, between about 15° to 165° to the magnetic field. This results in the beta electrons following both right and left handed helical trajectories with radii given by:

R(θ)=(mₒγ)V/qB sin(θ)

or R(θ)=R/sin(θ) (5)

V is the beta velocity amplitude perpendicular to the magnetic field (θ=90°). Hence, rather than a single beta helical trajectory outside the tube, there are multitude helical trajectories each with a different radius. The combined helical trajectories form a beta electron beam with a cross sectional area:

A=π(Rmax²−R²) (6)

where

Rₘₐₓ=)R/sin(15°=3.8*R (7)

Therefore, the beta electron flux (electrons/cm̂2-sec) around the tube for excimer generation is calculated from the product of the Kr-85 activity and mass inside the tube divided by this helical cross sectional area.

J_{beta}=A(t)*mass/(2.8πR²)

or J_{beta}=A(t)*mass/[2.8π(mₒγV/qB sin(θ))²] (8)

This beta flux can be controlled and increased by increasing the magnetic field strength since the cross sectional radius, R, and area are inversely proportional to 1/B and 1/B² respectively. Since the excimer generation rates increases with precursor gas pressure, beta electron energy and electron flux, the advantage of this collimated, high flux beta electron beam is that it increases the number of beta interactions per unit volume per second with the precursor gas atoms and increases the excimer photon generation rate. This in turn increases the power output from the surrounding photovoltaic cells.

The excimer photon generation rate dependence on the number of beta electron interactions with excimer precursor gas atoms defines an effective gain factor for the device above that of a single beta interaction with a noble gas atom to generate an excimer. The total beta electron energy loss as it travels though the precursor gas includes that from coulomb collision interactions, excitation to the excimer state, and gas ionization. The National Institutes of Standard's Continuous Slowing Down Approximation (CSDA) tables, referenced herein, provide the data for this calculation. Table 3 shows the beta CSDA factors and beta trajectory distances, L, to lose all its energy for several precursor noble gases. The beta trajectory distance is defined by:

L=(CSDA/gas density)=CSDA*RT/P (9)

where P/RT is the excimer precursor gas density based on its pressure, P, temperature, T, and the gas constant R (8.314 J/mole-K). Hence, the beta trajectory distance is inversely proportional to the gas pressure. Table 3 also lists the mean free path length, λ, for each gas.

TABLE 3

| | | | | Gas mean | ESTAR | | Beta |
|---|---|---|---|---|---|---|---|
| | | | Excimer | free path | CSDA range | Kr-85 Beta | distance |
| Noble | Atomic | Density | energy | (cm) * | factor | Energy for | (cm) |
| gas | mass | (gm/cm3) * | (eV) | λ | (gm/cm²) | ESTAR | L |
| Kr | 83.78 | 3.738 | 8.49 | 5.23e−6 | 0.1028 | @251 KeV | 27.50 |
| Xe | 131.29 | 5.857 | 7.21 | 3.78e−6 | 0.1126 | @251 KeV | 19.22 |
| Ar | 39.94 | 1.781 | 9.84 | 6.83e−6 | 0.0892 | @251 KeV | 50.06 |

* at 1 atmosphere pressure, 273 K

The gain factor is calculated from an energy balance on the beta energy entering the excimer precursor gas is divided by the excimer photon energy exiting the gas. For Kr-85 and P-32, dividing the respective average beta energy by the gas excimer photon energy provides the gain factors, G, shown in Table 5. Also shown in Table 5 are G values based on the beta energy divided by the noble gas first ionization energy. These G factors range from about 3 to 9×10⁴ for the average beta energies.

TABLE 4

| Excimer | Eph, photon energy (eV) | |
|---|---|---|
| emitter | and wavelength (nm) | Precursor gas |
| Ar₂* | 9.84 (126) | Ar |
| Kr₂* | 8.49 (146) | Kr |
| Xe₂* | 7.21 (172) | Xe |
| ArF* | 6.42 (193) | Ar, NF₃ |
| KrF* | 5.01 (248) | Kr, NF₃ |
| XeCl* | 4.03 (308) | Xe, HCl |
| XeF* | 3.53 (351) | Xe, NF₃ |

TABLE 5

| | Photon | | | G | G |
|---|---|---|---|---|---|
| | energy (eV) | Ioni- | | Beta | Beta |
| | and | zation | Beta Energy | KeV/ | KeV/ |
| Excimer | wavelength | energy | Average and | photon | ionization |
| emitters | (nm) | (eV) | Maximum | energy | energy |
| Ar₂* | 9.84 | 12.1 | Kr-85@251 KeV | 2.6e4 | 2.1e4 |
| | (126) | | P-32@695 KeV | 7.1e4 | 5.7e4 |
| Kr₂* | 8.49 | 13.9 | Kr-85@251 KeV | 2.9e4 | 1.8e4 |
| | (146) | | P-32@695 KeV | 8.1e4 | 5.0e4 |
| Xe₂* | 7.21 | 15.7 | Kr-85@251 KeV | 3.5e4 | 1.6e4 |
| | (172) | | P-32@695 KeV | 9.6e4 | 4.4e4 |

With these gain factors, the electrical power output generated by the device is calculated with the following equation:

Power=A(t)*G*Efex*(Eph*Efpv) (watts/gm) (10)

### Where:

A(t)=the activity of radioisotope (Curies/gm)
G=Gain factor
Eph=excimer photon energy
Efex=efficiency of excimer production
Efpv=efficiency of the photovoltaic cell

As discussed in “Vacuum Ultraviolet Rare Gas Excimer Light Source” referenced herein, the excimer generation efficiency, Efex, is about 50% for an electron gun with acceleration voltages of 20 to 40 KV. Since the generation rate scales with electron energy, beta electrons will have higher efficiency.

In one embodiment of the device illustrated in FIG. 2, the beta electron transparent titanium tube (1) contains 1000 Curies of Krypton-85 gas as the beta emitting radioisotope. From Table 1, a tube volume 72.5 cm³ is required for 1000 Curies of Kr-85 gas at a tube pressure 10 atmospheres and 20° C. (13.8 Ci/cc). The tube diameter and length are calculated from the Table 2 cyclotron radius, R, for Kr-85 beta electrons at 251 KeV. This radius is 0.94 cm in the 0.2 T field at a 90° emission angle to the magnetic field. The titanium tube radius is set at 95% of R or 0.89 cm to prevent this closest beta trajectory from hitting the outside of the tube. Based on this tube volume and radius, the tube length is 28.7 cm.

FIG. 2 also illustrates the titanium beta emitting tube (1) is enclosed within a sealed, larger diameter photon transparent fused quartz tube (3). This second tube contains the precursor gas pressurized to one atmosphere or other pressures for excimer generation by the beta electrons emitted through the titanium tube. Independent control of the Kr-85 gas pressure and excimer precursor gas pressure allow optimization of the excimer photon generation rate.

This photon transparent tube diameter is calculated from the radius of beta electrons exiting the titanium tube with an emission angle is 15° since they have the largest helical radius. Equation 6 shows the helical radius at this angle is 3.86 times R or 3.63 cm. The radius of the transparent excimer tube is chosen as 1% larger for a transparent tube radius of 3.66 cm. With this radius, none of the 251 KeV beta trajectories will hit the transparent tube wall. The 678 KeV maximum energy Kr-85 betas have an emission rate near zero. However, even those few beta electrons will not hit the tube wall for emission angles greater than 30°. With these calculations, the assembled device has an outer diameter of 7.33 cm and length of 28.7 cm. The photon emission area for the excimer photon tube (excluding the tube ends) is a 2π3.66*28.7 or 660 cm².

In operation, helical beta electron trajectories with 90° emission angles follow circular paths through the surrounding excimer precursor gas while those with 15° emission angles follow elongated helical paths. The beta trajectory path length through the gas, regardless of emission angle, is the CSDA length listed in Table 3. In this embodiment, the precursor gas is xenon at one atmosphere. Thus, the 251 KeV beta electron trajectory length in the gas, L, is 19.2 cm. The number of turns along the helical trajectory (L/Lh) the beta electrons will make before dissipating their energy in the gas are listed in Table 6. For any emission angle, θ, out of the titanium tube, the trajectory length for one helical turn is:

Lh=sqrt(H²+R(θ)²) (11)

where:

H=2πR(θ)cotan(θ)0.1°<θ<90°

or

H=((mₒγ)V/qB sin(θ))cotan(θ) (12)

TABLE 6

| Emission angle θ | Helix radius R(θ) | H = 2πR(θ)cotan(θ) | Lh | L/Lh |
|---|---|---|---|---|
| 15 | 0.0363 | 0.853 | 0.853 | 0.3 |
| 45 | 0.0133 | 0.084 | 0.085 | 3.2 |
| 60 | 0.0109 | 0.039 | 0.041 | 6.6 |
| 90 | 0.0094 | 0.000 | 0.009 | 28.7 |

L = 19.2 cm for xenon at one atmosphere

The device electric power is generated by wide-bandgap photovoltaic cells surrounding the excimer tube to absorb the photon emissions. Wideband-gap photovoltaic cells, such as GaP, 6H-SiC, or doped diamond, with respective band-gaps of 2.3, 3.0, and 5.5 eV, directly absorb the excimer photon energy to generate electrical power through a load. The efficiencies for these single junction wide-band gap photovoltaic cells, Epv, are about 15%.

In another embodiment of the device, the emitted excimer photons are converted with phosphors to longer wavelength photons. The phosphors are coated on the excimer gas tube. The photons emitted from the phosphors are then absorbed by high efficiency multi junction photovoltaic cells, such as GaInP₂/InGaAs/Ge, to generate an increased power output. Multi-junction cells, such as those manufactured by Spectrolab™, have approximately 30% power generation efficiency.

An example of a suitable phosphors a described in “Bright White-Emitting Phosphors for Hg Free Lamps and White LED Applications” incorporated herein by reference is Ba2Gd (BO3)2Cl:Dy³⁺ which provides a white light output when illuminated with the 172 nm photons produced by Xe₂* excimers. Another suitable phosphor is Ca₅Cl:Mn which is used for UV photon conversion to white light in fluorescent tubes and UV LEDs. Other suitable commercial excimer to white light phosphors are available from Spectra Systems referenced herein. These excimer to white light conversion phosphors have quantum efficiencies, Efphos, of up to 90%.

With these phosphor modifications, the device power output equation is:

Power=A(t)*G*Efex*(Eph*Ephos*Ehpv) (watts/gm) (13)

where:
Eph=excimer photon energy
Efex=excimer generation efficiency
Efphos=excimer photon to phosphor emission efficiency
Efpv=photovoltaic cell efficiency

Table 7 lists the electric power output from the device at several Kr-85 Curie loadings. The Table calculations use a Gain factor of 3×10⁴, excimer photon generation efficiency, Efex, of 55% per beta electron interaction, VUV photon to white light phosphor quantum efficiency, Efphos, of 90% and triple junction photovoltaic cell efficiency, Efpv, of 30%. In this example, argon is the noble gas for Ar₂* excimer generation. This excimer photon energy, Eph=9.84 eV.

TABLE 7

| | | | | Ar₂* | 30% photon |
|---|---|---|---|---|---|
| | | | | (9.84 eV | Wide band |
| | | | Gain Factor: | photon) | gap PV |
| | | Beta | G = 3 × 10⁴ | Excimer | efficiency |
| Kr-85 | | Emission | Excimer | Photons | PV system |
| Gas | | Rate | Photons/beta | Emitted | output |
| (grams) | Curies | (beta/sec) | at Eph = 60% | (watts) | (mWatts) |
| 0.025 | 10 | 3.70e11 | 6.7e15 | 0.010 | 2.6 |
| 0.254 | 100 | 3.7e12 | 6.7e16 | 0.096 | 25.9 |
| 2.544 | 1000 | 3.7e13 | 6.7e17 | 0.961 | 259.5 |
| 4.90 | 1927 | 7.3e13 | 1.2e18 | 1.852 | 500 |
| 9.80 | 3532 | 1.4e14 | 2.8e18 | 3.704 | 1000 |

From Table 7, the device output is about 102 miliwatt/gram of Kr-85 or 0.26 miliwatt/Curie. The illustrative device embodiment can deliver one watt of power with 3532 Curies in the radioisotope tube.

The energy conversion efficiency of the illustrative device, η is calculated from the ratio of the output to input power.

η=Power/Pin (14)

where Pin is A(t)*Ebeta and Ebeta is the radioisotope average beta emission energy. Combining Equations 13 and 14 yields:

η=G*(Eph/Ebeta)*Eex*Ephos*Epv (15)

For the argon excimer with Eph=8.94 and G=3×10⁴,

η=3×10⁴*(9.84 ev/(251 KeV)*(0.6*0.9*0.3)

for efficiency of about 17.4%

The Ebeta term for electrons emitted from the Kr-85 atoms can be further refined by including beta kinetic energy losses in transiting the titanium tube wall. This energy loss is also calculated with the National Institute of Standards tables referenced herein. The NIST ESTAR stopping power tabulation for titanium with 251 KeV beta electrons is 1.804 MeV-cm²/gm or 8.1 MeV/cm when multiplied by the titanium density of 4.5 gm/cm³. Thus, a 0.03 mm titanium tube wall thickness would decrease the exiting beta energy by 24 KeV. This decreased initial energy can then be used to modify the G gain factor and revise the power output. With this correction, the device efficiency is about 19%.

In another embodiment of the device, the titanium tube holding the Kr-85 can be constructed of other beta electron transparent materials such as aluminum, Al₂O₃, silicon oxide, silicon carbide, silicon nitride, boron carbide, and boron nitride. In each case, the tube wall thickness is calculated from its bursting strength at the desired Kr-85 gas pressure. The beta energy loss through the tube wall is then calculated with the tube material density and the NIST ESTAR data referenced herein at the average radioisotope decay energy. The outside of these beta emitting tubes can also be coated with a thin layer aluminum mirror to reflect excimer light back towards the photovoltaic cells.

In another embodiment, the Kr-85 gas pressure inside the titanium tube is greatly reduced while maintaining the same mass of radioisotope by adsorbing the Kr-85 gas on a 5 Å molecular sieve adsorbent placed inside the tube. This material can adsorb and store 4.66×10⁻³ moles of gas per cubic centimeter of material at one atmosphere pressure. This is equivalent to a Kr-85 gas density at 91 atmospheres. The Kr-85 beta electrons lose very little energy passing through the porous molecular sieve material. Other adsorbents for this embodiment include activated carbon pellets and the metal organic framework materials such as MOF-177 and MOF-505. This pressure reduction by the Kr-85 adsorbent greatly reduces the required wall thickness of the radioisotope tube. This in turn decreases the energy loss of the beta electrons as they transit the tube wall.

In another embodiment, the excimer precursor gas tube for excimer generation can be constructed of vacuum ultraviolet (VUV) and UV transparent materials such as Supracil™ fused quartz, sapphire (Al₂O₃), MgF₂, and CaF₂. In addition to tubes, a photon transparent rectangular box can also be constructed from bonded plates of these materials to hold the precursor gas.

The device is not limited to radioisotope materials such as Kr-85 gas. In another embodiment, the gas inside the tube can be replaced with a beta transparent tube containing or coated with a solid radioisotope source. These emitted beta electrons will also be collimated into helical trajectories around the tube. In this embodiment radioisotopes such as P-32 or longer half life materials like Pm-147, Sr-90, and Ni-63 can be deposited in the tube. In an example of this embodiment, P-32 with a 14.3 day half-life and a 695 KeV average beta energy has a Pin value of 0.0041 Watts/Ci. Table 3 lists the G factor of P-32 beta electrons in argon as 7.1×10⁴. Table 8 lists the power output with this radioisotope with the same efficiency assumptions as used in Table 7.

TABLE 8

| | | | Gain Factor: | Ar₂* | 30% photon |
|---|---|---|---|---|---|
| | | | G = 7.1 × 10⁴ | (9.84 eV | Wide band |
| | | | @695 KeV | photon) | gap PV |
| | | Beta | Excimer | Excimer | efficiency |
| | | Emission | Photons/beta | Photons | PV system |
| P-32 | | Rate | at Eph = 55% | Emitted | power output |
| (grams) | Curies | (beta/sec) | efficiency | (watts) | (mWatts) |
| 3.5e−3 | 1000 | 3.7e13 | 1.4e18 | 2.275 | 614 |
| 5.70e−3 | 1628 | 6.02e13 | 2.4e18 | 3.704 | 1000 |

The illustrative device power output from Table 7 is 6.14×10⁻⁴ Watts/Ci vs. 2.60×10⁻⁴ Watts/Ci for Kr-85. Table 7 and Table 8 data illustrate the device produces far more electrical power per Curie of radioisotope than any prior-art power generation device utilizing beta electrons.

To further increase the total electrical power output, another embodiment of the invention is illustrated in FIG. 4. Here several of the devices are arranged end-to-end, in parallel or in a ring-like polygon configuration to increase the excimer photon illumination of the surrounding photovoltaic cells. Further scaling-up of the electrical power output can be achieved by stacking several of the ring structures vertically within a hexagonal box constructed of flat photovoltaic cell walls. Flexible photovoltaic panels could also be used in this configuration.

Variations of the various elements or conditions specified above can also be employed. Illustratively, the excimer precursor gas can be provided in the enclosed space at a pressure from about 0.1 to 10 atmospheres in some embodiments; the magnetic field can have a strength between about 0.01 and 3 Tesla; and/or apparatuses can include multiple of the above-described devices arranged end-to-end, in parallel, or in polygons. In addition or alternatively, it is contemplated that devices of the invention can include magnetic fields that alter the trajectories of the beta electrons emitted by the radioisotope in other ways that increase the path length travelled by the beta electrons in the excimer precursor gas, as compared to a corresponding device without the magnetic field. The trajectories of and paths travelled by the beta electrons in the precursor gas can be helical as disclosed above or otherwise curved. In some embodiments, the magnetic field can be effective to increase the lengths of the paths travelled by the beta electrons through the precursor gas, on average, by at least about 100%, or at least about 200%; as compared to a corresponding device without the magnetic field; additionally or alternatively, the magnetic field can be effective to increase the number of photons generated by the excimer gas (upon excitation by the beta electrons) by at least about 100%, or at least about 200%, as compared to a corresponding device without the magnetic field. These and other variations will be apparent to those of ordinary skill in the art from the descriptions herein.

### CITED PUBLICATIONS

The following publications are hereby incorporated herein by reference in their entirety.
Fundamentals of Electron Motion, Harman, W. H, McGraw-Hill (1953)
Advances in Betavoltaic Power, Revankar, S. and Adams, T, J. Energy Power Sources, Vol. 1, 321-329 (2014)
Nuclear Driven Flash Lamps, Prelas, M., Boody, F., Miley, G. and Kunze, F., Laser and Particle Beams, Vol. 6, p. 25-62, (1988)
Development of Electron Guns for Excimer Light Sources in the Vacuum UV, R. Steinhuebl, IEEE Transactions on Electron Devices, Vol. 52, Issue 5, (2005)
Vacuum ultraviolet rare gas excimer light source, J. Wieser, D. E. Murnick, Ulrich, H. A. Huggins, A. Liddle and W. L. Brown, Rev. Sci. Instrum., 1360 (1997)
Excimer lamps, Ulrich Kogelschatz, Proc. SPIE 5483, Atomic and Molecular Pulsed Lasers Vol. 272, May 3, 2004 (kinetics)
National Institute of Standards ESTAR Data, physics.nist.gov/PhysRefData/Star/Text/ESTAR.html
Bright White-Emitting Phosphors for Hg-Free Lamps and White LED Applications, L. Zhao, D. Wang, Y. Wang, J. Am. Ceram. Soc., 98, 1195 (2015).
Spectra Systems, www.phosphor-technology.com

The present invention is described and illustrated herein with reference to preferred embodiments that constitute the best means known to the applicant for making and using the invention. It will be appreciated that various modifications, alterations, and substitutions may be apparent to one skilled in the art and may be made without departing from the invention. Accordingly the scope of the invention is defined by the following claims.

1. A device for energy conversion, comprising:
a beta electron emitting radioisotope;
an enclosed space adjacent to the beta electron emitting radioisotope, for receiving beta electrons emitted by the radioisotope;
an excimer precursor gas sealed within the enclosed space, the excimer precursor gas selected to generate photons when excited by beta electrons emitted by the radioisotope and entering the enclosed space; and
a magnetic field effective to modify trajectories of beta electrons emitted by the radioisotope.

1A-1D. (canceled)

2. The device of claim 1, which is a device for generating electrical power, the device also comprising:
one or more photovoltaic cells positioned to absorb the photons and thereupon generate electrical power.

3. The device of claim 2, wherein the one or more photovoltaic cells are positioned external of the second housing, and wherein walls of the second housing are transparent or at least essentially transparent to the photons.

4. The device of claim 2, wherein the one or more photovoltaic cells include a plurality of photovoltaic cells.

5. The device of claim 1, wherein the first housing has a first housing axis, and wherein the magnetic field is aligned along the first housing axis.

6. The device of claim 1, wherein the first housing is a tubular housing.

7. The device of claim 6, wherein the helical trajectories of at least some of the beta electrons circumnavigate the external wall of the tubular housing at least one time within the enclosed space.

8. The device of claim 6, wherein the helical trajectories of at least some of the beta electrons circumnavigate the external wall of the tubular housing at least two times within the enclosed space.

9. The device of claim 1, wherein the beta electron emitting radioisotope is H-3, Kr-85, P-32, P-33, S-35, Pm-147, Ni-63, Sr-90, or Eu-155

10. The device of claim 1, wherein the magnetic field has a strength between 0.01 and 3 Tesla.

11. The device of claim 1, comprising first and second permanent magnets producing the magnetic field.

12. The device of claim 11, wherein the permanent magnets each have poles that are axially aligned with the first housing axis.

13. The device of claim 12, wherein the first permanent magnet is positioned adjacent and external of a first end of the first housing, and the second permanent magnet is positioned adjacent and external of a second end of the first housing.

14. The device of claim 11, wherein the first and second permanent magnets comprise ceramic Strontium Ferrite (Sr_{0.6}Fe₂O₃), Samarium Cobalt (Sm₂Co₁₇), or Neodymium Iron Boron (Nd₂Fe₁₄B),

15. The device of claim 1, wherein the excimer precursor gas is pressurized from 0.1 to 10 atmospheres.

16. The device of claim 1, wherein the excimer precursor gas comprises xenon, argon, krypton or mixtures thereof.

17. The device of claim 1, wherein the excimer precursor gas comprises a helium buffered mixture of xenon with nitrogen trifluoride, a helium buffered mixture of xenon with hydrogen fluoride, a helium buffered mixture of argon with nitrogen fluoride, a helium buffered mixture of argon with hydrogen chloride, a helium buffered mixture of krypton with nitrogen fluoride, or a helium buffered mixture of krypton with hydrogen chloride.

18. The device of claim 1, wherein the first housing has housing walls comprised of silicon nitride, boron nitride, silicon carbide, graphite, silicon oxide, titanium, copper, palladium, aluminum, or aluminum oxide.

19. The device of claim 1, wherein the external surface of the first housing is defined by a metallic coating that reflects the photons.

20. The device of claim 1, wherein the radioisotope is a solid bonded to the outside surface of a small diameter tube or wire such that the beta electrons are emitted directly into the axial magnetic field.

21. The device of claim 1, wherein the second housing has housing walls comprised of fused quartz, fused silica, Al₂O₃, or MgF₂.

22. The device of claim 1, wherein the second housing has a phosphor coating that absorbs the photons generated by the excimer gas and emits phosphor-generated photons having longer wavelengths than the photons emitted by the excimer gas.

23. The device of claim 22, wherein the phosphor coating comprises Ba₂Gd (BO₃)₂Cl:Dy³⁺, Ca₅Cl:Mn, or Ca₅F(PO₄)₃: Sb,Mn.

24. The device of claim 1, wherein the radioisotope comprises Kr-85 gas.

25. The device of claim 24, wherein the Kr-85 gas is pressurized to within 80% of a burst pressure of the first housing.

26. The device of claim 1, where the radioisotope comprises Kr-85 in a liquid state.

27. The device of claim 24, wherein the Kr-85 gas is adsorbed on a solid material received in the interior chamber.

28. The device of claim 27, wherein the solid material comprises a molecular sieve, a quartz aerogel, or a metal-organic framework adsorbent.

29. An apparatus for energy conversion, comprising multiple devices according to claim 1.

30. The apparatus of claim 29, wherein the devices are arranged end-to-end, in parallel, or in polygons.

31. The apparatus of claim 29, wherein the multiple devices are stacked within a hexagonal column with its sides fabricated from photovoltaic panels.

32. A method for energy conversion, comprising:
emitting beta electrons from a beta electron emitting radioisotope and into an enclosed space containing an excimer precursor gas selected to generate photons when excited by the beta electrons; and
applying a magnetic field so as to impart modified trajectories to the beta electrons emitted by the radioisotope and entering the enclosed space, wherein the modified trajectories extend at least in part through the enclosed space, preferably wherein the modified trajectories are curved trajectories, more preferably wherein the modified trajectories are helical trajectories.

33-63. (canceled)

64. The device of claim 1, wherein the magnetic field is effective to increase a length of a path travelled by the beta electrons within the excimer precursor gas by at least about 100%.

65. The device of claim 1, wherein the magnetic field is effective to increase the number of photons generated by the excitation of the excimer precursor gas by the beta electrons by at least about 100%.

66. The device of claim 1, wherein the magnetic field is effective to modify trajectories of the beta electrons emitted by the radioisotope so as to increase a path length traveled by the beta electrons through the excimer precursor gas.

67. The device of claim 1, wherein the magnetic field is effective to impart curved trajectories to the beta electrons emitted by the radioisotope and entering the enclosed space, wherein the curved trajectories extend at least in part through the enclosed space.

68. The device of claim 1, wherein the magnetic field is effective to impart helical trajectories to the beta electrons emitted by the radioisotope and entering the enclosed space, wherein the helical trajectories extend at least in part through the enclosed space.

69. The device of claim 1, comprising:
a first housing having a first housing axis and defining an interior chamber, wherein the beta electron emitting radioisotope is sealed within the interior chamber of the first housing;
a second housing enclosing at least a portion of the first housing and defining the enclosed space between an external surface of the first housing and an internal surface of the second housing
